(19) United States
(12) Patent Application Publication
(10) Pub. No.: US 2016/0059540 A1
(43) Pub. Date: Mar. 3, 2016

(54) CONTROLLING FLEXOGRAPHIC PRINTING SYSTEM PRESSURE USING OPTICAL MEASUREMENT

(71) Applicants: Gary A. Smith, Rochester, NY (US); Michael G. Shaughnessy, Hemlock, NY (US); Thomas P. Bell, Rochester, NY (US)

(72) Inventors: Gary A. Smith, Rochester, NY (US); Michael G. Shaughnessy, Hemlock, NY (US); Thomas P. Bell, Rochester, NY (US)

(21) Appl. No.: 14/470,978

(22) Filed: Aug. 28, 2014

(51) Int. Cl. B41F 5/24; G06F 3/044

(52) U.S. Cl. CPC B41F 5/24; G06F 3/044

(57) ABSTRACT

An ink transfer pressure between cylinders in a flexographic printing system is controlled to provide consistent image quality. A flexographic printing plate is provided that includes an image region arranged to print an image pattern having printed image features and a pressure characterization region outside the image region arranged to a print pressure characterization pattern. Ink is transferred from an anilox cylinder to the flexographic printing plate with a first transfer pressure, and from the flexographic printing plate to a recording medium with a second transfer pressure. An optical property of at the printed pressure characterization pattern is measured and used to adjust one or both of the first and second transfer pressures.

### FIELD OF THE INVENTION

This invention pertains to the field of flexographic printing, and more particularly to a method of setting an ink transfer pressure between cylinders by optical measurement of printed features.

### BACKGROUND OF THE INVENTION

Flexography is a method of printing or pattern formation that is commonly used for high-volume printing runs. It is typically employed for printing on a variety of soft or easily deformed materials including, but not limited to, paper, paperboard stock, corrugated board, polymeric films, fabrics, metal foils, glass, glass-coated materials, flexible glass materials and laminates of multiple materials. Coarse surfaces and stretchable polymeric films are also economically printed using flexography.

Flexographic printing members are sometimes known as relief printing members, relief-containing printing plates, printing sleeves, or printing cylinders, and are provided with raised relief images onto which ink is applied for application to a printable substrate. While the raised relief images are inked, the recessed relief “floor” should remain free of ink.

Although flexographic printing has conventionally been used in the past for printing of images, more recent uses of flexographic printing have included functional printing of devices, such as touch screen sensor films, antennas, and other devices to be used in electronics or other industries. Such devices typically include electrically conductive patterns.

Touch screens are visual displays with areas that may be configured to detect both the presence and location of a touch by, for example, a finger, a hand or a stylus. Touch screens may be found in televisions, computers, computer peripherals, mobile computing devices, automobiles, appliances and game consoles, as well as in other industrial, commercial and household applications. A capacitive touch screen includes a substantially transparent substrate which is provided with electrically conductive patterns that do not excessively impair the transparency—either because the conductors are made of a material, such as indium tin oxide, that is substantially transparent, or because the conductors are sufficiently narrow that the transparency is provided by the comparatively large open areas not containing conductors. As the human body is also an electrical conductor, touching the surface of the screen results in a distortion of the screen's electrostatic field, measurable as a change in capacitance.

Projected capacitive touch technology is a variant of capacitive touch technology. Projected capacitive touch screens are made up of a matrix of rows and columns of conductive material that form a grid. Voltage applied to this grid creates a uniform electrostatic field, which can be measured. When a conductive object, such as a finger, comes into contact, it distorts the local electrostatic field at that point. This is measurable as a change in capacitance. The capacitance can be changed and measured at every intersection point on the grid. Therefore, this system is able to accurately track touches. Projected capacitive touch screens can use either mutual capacitive sensors or self capacitive sensors. In mutual capacitive sensors, there is a capacitor at every intersection of each row and each column. A 16×14 array, for example, would have 224 independent capacitors. A voltage is applied to the rows or columns. Bringing a finger or conductive stylus close to the surface of the sensor changes the local electrostatic field which reduces the mutual capacitance. The capacitance change at every individual point on the grid can be measured to accurately determine the touch location by measuring the voltage in the other axis. Mutual capacitance allows multi-touch operation where multiple fingers, palms or styli can be accurately tracked at the same time.

Self-capacitance sensors can use the same x-y grid as mutual capacitance sensors, but the columns and rows operate independently. With self-capacitance, the capacitive load of a finger is measured on each column or row electrode by a current meter. This method produces a stronger signal than mutual capacitance, but it is unable to resolve accurately more than one finger, which results in “ghosting”, or misplaced location sensing.

WO 2013/063188 by Petcavich et al. discloses a method of manufacturing a capacitive touch sensor using a roll-to-roll process to print a conductor pattern on a flexible transparent dielectric substrate. A first conductor pattern is printed on a first side of the dielectric substrate using a first flexographic printing plate and is then cured. A second conductor pattern is printed on a second side of the dielectric substrate using a second flexographic printing plate and is then cured. In some embodiments the ink used to print the patterns includes a catalyst that acts as seed layer during subsequent electroless plating. The electrolessly plated material (e.g., copper) provides the low resistivity in the narrow lines of the grid needed for excellent performance of the capacitive touch sensor. Petcavich et al. indicate that the line width of the flexographically printed material can be 1 to 50 microns.

To improve the optical quality and reliability of the touch screen, it has been found to be preferable that the width of the grid lines be approximately 2 to 10 microns, and even more preferably to be 4 to 8 microns. Printing such narrow lines stretches the limits of flexographic printing technology. It has been found to be difficult to achieve a desired tolerance of plus or minus one micron in line width tolerance.

Line width of printed features can be affected by the ink transfer pressure for providing ink to the flexographic printing plate and also by the ink transfer pressure for printing the ink from the flexographic printing plate onto the substrate. In conventional flexographic printing applications where the tolerance on printed feature size is substantially looser than for touch screen sensor films, the operator of the flexographic printing system can simply inspect the printed image and adjust the ink transfer pressures as needed. However, for printed features such as the grid lines of a touch sensor film, there are two problems with this approach. First, a visual inspection is not sufficiently sensitive to achieve line width tolerances of plus or minus one micron. Second, by their very nature, the grid lines of a touch sensor film are intended to be difficult to see.

What is needed is a method for setting the ink transfer pressure in a flexographic printing system such that very narrow lines, which are difficult to see, can be printed with tight tolerance on line width.

### SUMMARY OF THE INVENTION

The present invention represents a method of controlling an ink transfer pressure between cylinders in a flexographic printing system, the method comprising:

providing a flexographic printing plate on a printing cylinder, the flexographic printing plate including:

an image region including a plurality of raised printing elements arranged to print an image pattern having printed image features corresponding to the raised printing elements, wherein the printed image features have a smallest lateral dimension that is less than 25 microns; and

one or more pressure characterization regions outside the image region, each pressure characterization region including a plurality of raised printing elements arranged to print a pressure characterization pattern having printed characterization features corresponding to the raised printing elements;

transferring ink from an anilox cylinder to the flexographic printing plate on the printing cylinder, wherein the anilox cylinder and the printing cylinder contact each other with a first transfer pressure;

advancing a recording medium through a nip between the printing cylinder and an impression cylinder such that ink is transferred from the flexographic printing plate to the recording medium to print the image pattern and the pressure characterization patterns, wherein the printing cylinder and the impression cylinder contact each other with a second transfer pressure;

measuring an optical property of at least one printed pressure characterization pattern; and

adjusting one or both of the first and second transfer pressures responsive to the measured optical property of the at least one printed pressure characterization pattern.

This invention has the advantage that the consistency of the image characterization of the printed image patterns will be improved.

It has the additional advantage that the pressure characterization patterns and the image patterns can be designed to have similar image characteristics so that they will respond in a similar way to transfer pressure variations.

It has the further advantage that optical measurements of the pressure characterization patterns can provide a higher signal-to-noise than similar optical measurements made on the image patterns.

### BRIEF DESCRIPTION OF THE DRAWINGS

FIG. 1 is a schematic side view of a flexographic printing system for roll-to-roll printing on both sides of a substrate;

FIG. 2 is a prior art flexographic printing apparatus using a fountain roller for ink delivery;

FIG. 3 is a prior art flexographic printing apparatus using a reservoir chamber for ink delivery;

FIG. 4 is a schematic side view of an inking system using a pivotable ink pan with a fountain roller in contact with the anilox roller;

FIG. 5 is a schematic side view of a flexographic printing system for use with embodiments of the invention;

FIG. 6 is a perspective of the flexographic printing system of FIG. 5;

FIG. 7 is a top view of a printing plate according to an exemplary embodiment, together with a printing cylinder;

FIG. 8A shows a portion of a web of substrate on which the printing plate of FIG. 7 has printed two successive prints;

FIG. 8B shows a portion of a web of substrate on which another printing plate embodiment has printed two successive prints;

FIG. 9 is a flow chart of a method for controlling an ink transfer pressure in accordance with the present invention;

FIG. 10 is a high-level system diagram for an apparatus having a touch screen with a touch sensor that can be printed using embodiments of the invention;

FIG. 11 is a side view of the touch sensor of FIG. 10;

FIG. 12 is a top view of a conductive pattern printed on a first side of the touch sensor of FIG. 11; and

FIG. 13 is a top view of a conductive pattern printed on a second side of the touch sensor of FIG. 11.

It is to be understood that the attached drawings are for purposes of illustrating the concepts of the invention and may not be to scale. Identical reference numerals have been used, where possible, to designate identical features that are common to the figures.

### DETAILED DESCRIPTION OF THE INVENTION

The present description will be directed in particular to elements forming part of, or cooperating more directly with, an apparatus in accordance with the present invention. It is to be understood that elements not specifically shown, labeled, or described can take various forms well known to those skilled in the art. In the following description and drawings, identical reference numerals have been used, where possible, to designate identical elements. It is to be understood that elements and components can be referred to in singular or plural form, as appropriate, without limiting the scope of the invention.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. It should be noted that, unless otherwise explicitly noted or required by context, the word “or” is used in this disclosure in a non-exclusive sense.

The example embodiments of the present invention are illustrated schematically and not to scale for the sake of clarity. One of ordinary skill in the art will be able to readily determine the specific size and interconnections of the elements of the example embodiments of the present invention.

As described herein, the example embodiments of the present invention provide a method for setting ink transfer pressure between cylinders in a flexographic printing system, particularly for printing functional devices incorporated into touch screens. However, many other applications are emerging for printing of functional devices that can be incorporated into other electronic, communications, industrial, household, packaging and product identification systems (such as RFID) in addition to touch screens. Furthermore, flexographic printing is conventionally used for printing of images and it is contemplated that the pressure setting method described herein can also be advantageous for such printing applications.

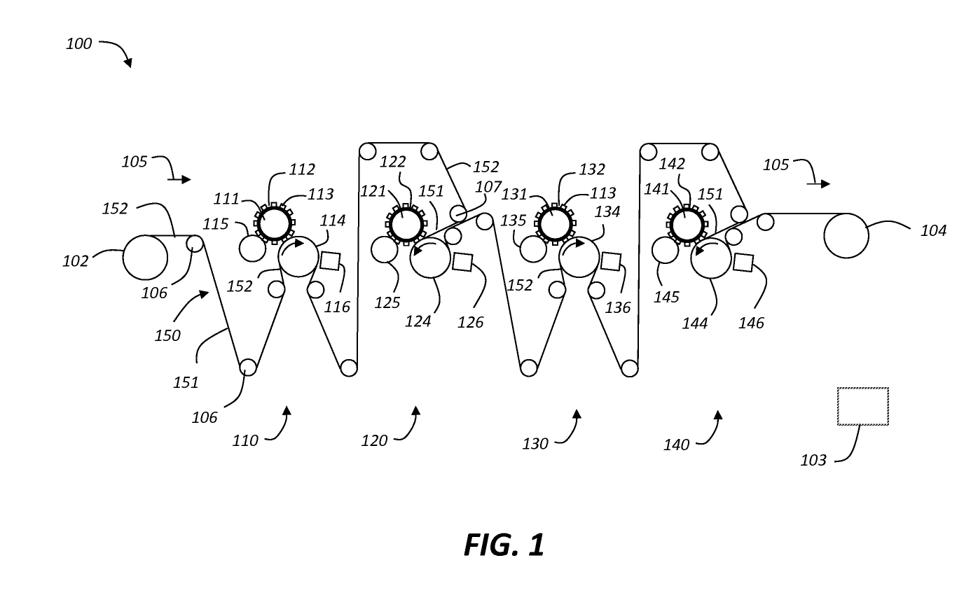

FIG. 1 is a schematic side view of a flexographic printing system 100 that can be used in embodiments of the invention for roll-to-roll printing on both sides of a substrate 150 (also called a recording medium herein). Substrate 150 is fed as a web from supply roll 102 to take-up roll 104 through flexographic printing system 100. Substrate 150 has a first side 151 and a second side 152. Substrate 150 can be a web of transparent film such as polyethylene terephthalate.

The flexographic printing system 100 includes two print modules 120 and 140 that are configured to print on the first side 151 of substrate 150, as well as two print modules 110 and 130 that are configured to print on the second side 152 of substrate 150. The web of substrate 150 travels overall in roll-to-roll direction 105 (left to right in the example of FIG. 1). However, various rollers 106 and 107 are used to locally change the direction of the web of substrate as needed for adjusting web tension, providing a buffer, and reversing a side for printing. In particular, note that in print module 120, roller 107 serves to reverse the local direction of the web of substrate 150 so that it is moving substantially in a right-to-left direction.

Each of the print modules 110, 120, 130, 140 includes some similar components including a respective printing cylinder 111, 121, 131, 141, on which is mounted a respective flexographic printing plate 112, 122, 132, 142, respectively. Each flexographic printing plate 112, 122, 132, 142 has raised features 113 defining an image pattern to be printed on the substrate 150. Each print module 110, 120, 130, 140 also includes a respective impression cylinder 114, 124, 134, 144 that is configured to force a side of the substrate 150 into contact with the corresponding flexographic printing plate 112, 122, 132, 142 at a nip formed between an impression cylinder and the corresponding printing cylinder. The impression cylinders 124 and 144 of print modules 120 and 140 (for printing on first side 151 of substrate 150) rotate counter-clockwise in the view shown in FIG. 1, while the impression cylinders 114 and 134 of print modules 110 and 130 (for printing on second side 152 of substrate 150) rotate clockwise in this view.

Each print module 110, 120, 130, 140 also includes a respective anilox roller 115, 125, 135, 145 for providing ink to the corresponding flexographic printing plate 112, 122, 132, 142. As is well known in the printing industry, an anilox roller (sometimes referred to as an anilox cylinder herein) is a hard cylinder, usually constructed of a steel or aluminum core, having an outer surface containing millions of very fine dimples, known as cells. How the ink is controllably transferred and distributed onto the anilox roller is described below. In some embodiments, some or all of the print modules 110, 120, 130, 140 also include respective UV curing stations 116, 126, 136, 146 for curing the printed ink on substrate 150. Also shown is controller 103 that can be used in some embodiments for controlling operation of various aspects of the flexographic printing process.

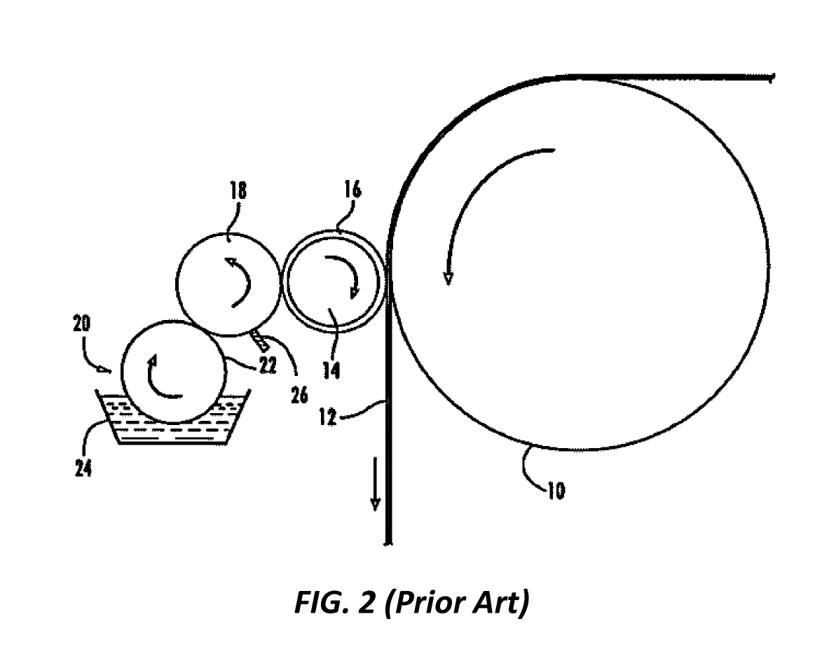

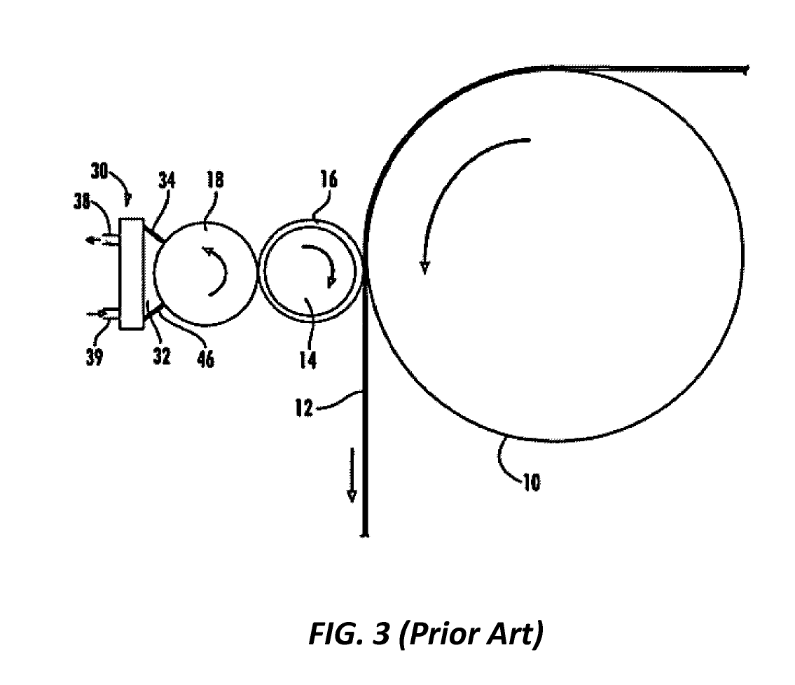

U.S. Pat. No. 7,487,724 to Evans et al. discloses inking systems for an anilox roller in a flexographic printing apparatus. FIG. 2 is a copy of Evans' FIG. 1 showing a flexographic printing apparatus using a fountain roller device 20 for delivering printing liquid (also called ink herein) to an anilox roller 18. FIG. 3 is a copy of Evans' FIG. 2 showing a reservoir chamber system 30 for delivering printing liquid to the anilox roller 18. The flexographic apparatuses shown in FIGS. 2 and 3 each comprises a rotatably driven impression cylinder 10 adapted to peripherally carry and transport a printable substrate 12, such as paper or a similar web-like material. A printing cylinder 14 is rotatably disposed adjacent the impression cylinder 10 in axially parallel coextensive relation to provide a nip through which the substrate 12 is advanced. The circumferential periphery of the printing cylinder 14 carries one or more flexible printing plates 16 formed with an image surface (not shown), for example in a relief image form, for peripherally contacting the circumferential surface of the impression cylinder 10 and the substrate 12 thereon. The anilox roller 18 is similarly disposed adjacent the printing cylinder 14 in axially parallel coextensive relation and in peripheral surface contact therewith.

The anilox roller 18 has its circumferential surface engraved with a multitude of recessed cells, which may be of various geometric configurations, adapted collectively to retain a quantity of printing liquid in a continuous film-like form over the circumferential surface of the anilox roller 18 for metered transfer of the liquid to the image surface on the printing plate 16 of the printing cylinder 14.

The flexographic printing apparatuses of FIGS. 2 and 3 differ principally in construction and operation in the form of the delivery device provided for applying printing liquid to the anilox roller 18. In the FIG. 2 apparatus, the delivery device is in the form of the so-called fountain roller device 20, wherein a cylindrical fountain roller 22 is disposed in axially parallel coextensive relation with the anilox roller 18 in peripheral surface contact therewith, with a downward facing lower portion of the fountain roller 22 being partially submerged in a pan 24 containing a quantity of printing liquid. The fountain roller 22 rotates and constantly keeps the engraved cell structure of the circumferential surface of the anilox roller 18 filled with the printing liquid, thereby forming a thin film of the liquid as determined by the size, number, volume and configuration of the cells. A doctor blade 26 is preferably positioned in angled surface contact with the anilox roller 18 downstream of the location of its contact with the fountain roller 22, as viewed in the direction of rotation of the anilox roller 18. The doctor blade 26 progressively wipes excess printing liquid from the surface of the anilox roller 18, which drains back into the pan 24.

In contrast, the flexographic printing apparatus shown in FIG. 3 does not utilize a fountain roller 22 (FIG. 2), but instead uses a reservoir chamber 32 positioned directly adjacent the anilox roller 18, with forwardly and rearwardly inclined blades 34, 46 disposed in axially extending wiping contact with the surface of the anilox roller 18 at a circumferential spacing from each other. Blade 34 is upstream of the contact of the printing liquid from reservoir chamber 32 with anilox roller 18, and serves as a containment blade. Blade 46 is downstream of the contact of the printing liquid from reservoir chamber 32 with anilox roller 18, and serves as a doctor blade to wipe excess printing liquid from the surface of the anilox roller 18. Printing liquid is continuously delivered into the reservoir chamber 32 at ink entry 39 and is exhausted from the reservoir chamber 32 at ink exit 38 so as to maintain a slightly positive fluid pressure within the reservoir chamber 32. In this manner, the reservoir chamber system 30 serves to constantly wet the peripheral surface of the anilox roller 18.

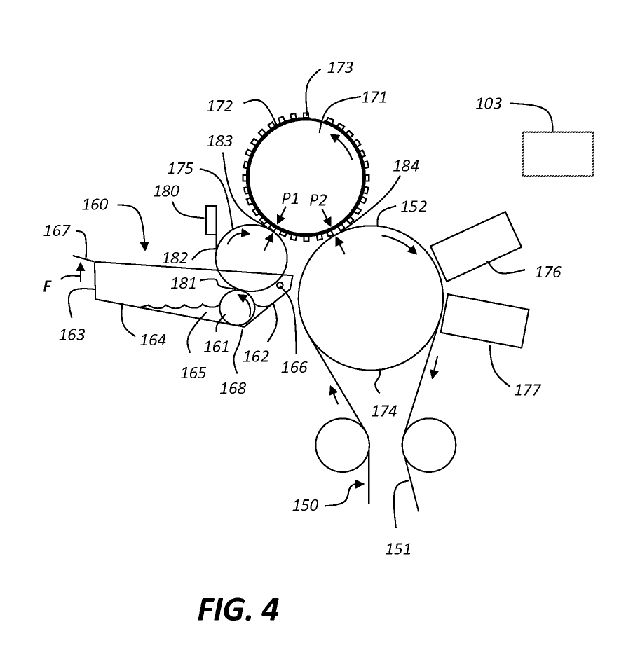

FIG. 4 shows a close-up side view of an ink pan 160 with a fountain roller 161 for use in flexographic printing systems for providing ink to anilox roller 175. The illustrated ink pan arrangement is adapted from commonly-assigned, co-pending U.S. patent application Ser. No. 14/146,867 to Shifley, entitled “Inking system for flexographic printing,” which is incorporated herein by reference. The configuration and rotation directions of impression cylinder 174, printing cylinder 171 and anilox roller 175 are similar to the corresponding impression cylinder 114, printing cylinder 111 and anilox roller 115 in print module 110 of FIG. 1.

Ink pan 160 includes a front wall 162 located nearer to impression cylinder 174, a rear wall 163 located opposite front wall 162 and further away from impression cylinder 174, and a floor 164 extending between the front wall 162 and the rear wall 163. The ink pan 160 also includes two side walls (not shown in FIG. 4) that extend between the front wall 162 and the rear wall 163 on opposite sides of the ink pan 160 and intersect the floor 164. It should be noted that there may or may not be distinct boundaries between the front wall 162, the rear wall 163, the floor 164 and the side walls. In some embodiments, some or all of the boundaries between these surfaces can be joined using rounded boundaries that smoothly transition from one surface to the adjoining surface.

Fountain roller 161 is partially immersed in an ink 165 contained in ink pan 160. Within the context of the present invention, the ink 165 can be any type of marking material, visible or invisible, to be deposited by the flexographic printing system 100 (FIG. 1) on the substrate 150. Fountain roller 161 is rotatably mounted on ink pan 160. Ink pan 160 is pivotable about pivot axis 166, preferably located near the front wall 162.

A lip 167 extends from rear wall 163. When an upward force F is applied to lip 167 as in FIG. 4, ink pan 160 pivots upward about pivot axis 166 until fountain roller 161 contacts anilox roller 175 at contact point 181. In the upwardly pivoted ink pan 160 the floor 164 tilts downward from rear wall 163 toward the front wall 162 so that fountain roller 161 is located near a lowest portion 168 of floor 164. If upward force F is removed from lip 167, ink pan 160 pivots downward under the influence of gravity so that fountain roller 161 is no longer in contact with anilox roller 175.

As described with reference to FIG. 1, a flexographic printing plate 172 (also sometimes called a flexographic master) is mounted on printing cylinder 171. In FIG. 4, flexographic printing plate 172 is a flexible plate that is wrapped almost entirely around printing cylinder 171. Anilox roller 175 contacts raised features 173 on the flexographic printing plate 172 at contact point 183. As printing cylinder 171 rotates counter-clockwise (in the view shown in FIG. 4), both the anilox roller 175 and the impression cylinder 174 rotate clockwise, while the fountain roller 161 rotates counter-clockwise. Ink 165 that is transferred from the fountain roller 161 to the anilox roller 175 is transferred to the raised features 173 of the flexographic printing plate 172 and from there to second side 152 of substrate 150 that is pressed against flexographic printing plate 172 at the nip by impression cylinder 174 at contact point 184.

In order to remove excess amounts of ink 165 from the patterned surface of anilox roller 175 a doctor blade 180, which is mounted to the frame (not shown) of the printing system, contacts anilox roller 175 at contact point 182. Contact point 182 is downstream of contact point 181 and is upstream of contact point 183. For the configuration shown in FIG. 4, in order to position doctor blade 180 to contact the anilox roller 175 downstream of contact point 181 where the fountain roller 161 contacts the anilox roller 175, as well as upstream of contact point 183 where the anilox roller 175 contacts the raised features 173 on the flexographic printing plate 172, doctor blade 180 is mounted on the printer system frame on a side of the anilox roller 175 that is opposite to the impression cylinder 174.

After printing of ink on the substrate, it is cured using UV curing station 176. In some embodiments, an imaging system 177 can be used to measure an optical property of at least a portion of the pattern printed on the substrate as discussed in further detail below. Also shown is controller 103 that can be used to control adjustments of ink transfer pressure according to the measured optical property in some embodiments.

Embodiments of the invention include measuring an optical property of at least one printed pattern that is outside the primary image region, and adjusting at least one ink transfer pressure between cylinders in the flexographic printing system. Controlling the ink transfer pressure is necessary to avoid performance degradations that can occur if the pressure is too low or too high. In particular, if a first transfer pressure P1 between the anilox roller 175 and the printing cylinder 171 on which the flexographic printing plate 172 is mounted is too great, ink can be transferred not only to the tops of the raised features 173 but also partially to the walls of the raised features 173 so that more ink is transferred to the flexographic printing plate 172 than is intended. This can result in broadening of the features in the printed pattern on substrate 150 to an extent that the pattern can tend to fill in, as well as increased variation in line width. Similarly if the second transfer pressure P1 between the anilox roller 175 and the printing cylinder 171 is too low, too little ink will be transferred to the flexographic printing plate 172, which can result in voids in the printed pattern on substrate 150. Likewise, if a second transfer pressure P2 between the printing cylinder 171 and the impression cylinder 174 at the nip through which the substrate 150 is advanced is too great the line width of the printed features on substrate 150 will be too large. Similarly if the second transfer pressure P2 between the printing cylinder 171 and the impression cylinder 174 is too small, the line width of the printed features on substrate 150 will be too small. Thus if the integrated optical density of the printed patterns is measured, the optical density of the printed pattern will be higher than a target value if the second transfer pressure P2 is too great, and the optical density will be lower than the target value if the second transfer pressure P2 is too small.

Herein, when it is said that the anilox roller 175 and the printing cylinder 171 contact each other with a first contact pressure P1, it is understood that the anilox roller 175 and the printing cylinder 171 indirectly contact each other through the flexographic printing plate 172. Similarly, when it is said that the printing cylinder 171 and the impression cylinder 174 contact each other with a second contact pressure P2, it is understood that the printing cylinder 171 and the impression cylinder 174 indirectly contact each other through the flexographic printing plate 172 and the substrate 150.

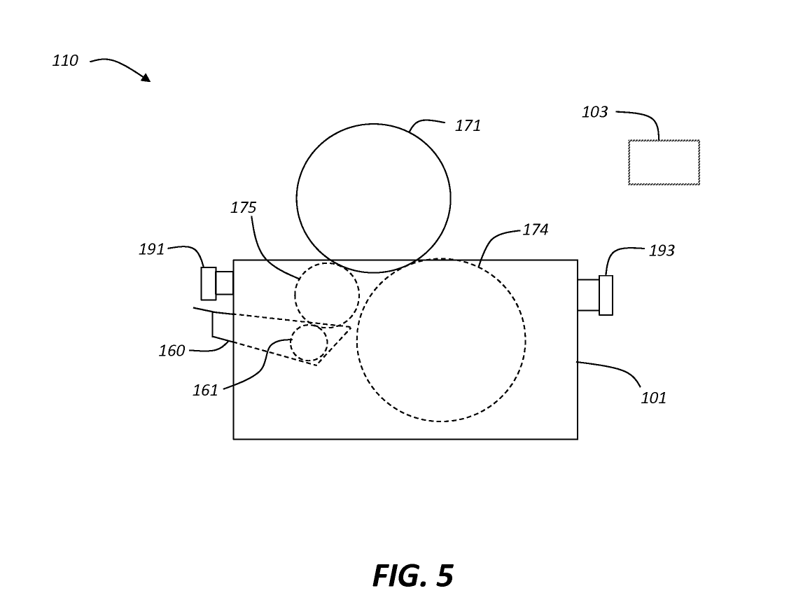

FIG. 5 shows a side view of a portion of a print module 110 appropriate for use in a flexographic printing system 100 (FIG. 1) including a frame 101, a printing cylinder 171, an impression cylinder 174, an anilox roller 175, an ink pan 160 and a fountain roller 161. FIG. 5 also shows an anilox cylinder pressure adjustment 191 for moving anilox roller 175 toward or away from printing cylinder 171 (using a mechanism which is not shown), thereby changing the ink transfer pressure between the anilox roller 175 (i.e., the anilox cylinder) and the printing cylinder 171. Also shown is an impression cylinder pressure adjustment 193 for moving impression cylinder 174 toward or away from printing cylinder 171 (using a mechanism which is not shown), thereby changing the ink transfer pressure between the impression cylinder 174 and the printing cylinder 171. In some embodiments, anilox cylinder pressure adjustment 191 and impression cylinder pressure adjustment 193 are knobs that can be turned manually. In other embodiments the anilox cylinder pressure adjustment 191 and impression cylinder pressure adjustment 193 can be motor-driven under the control of controller 103.

The anilox cylinder pressure adjustment 191 and impression cylinder pressure adjustment 193 can use various adjustment mechanisms for adjusting their respective pressures. Generally the adjustment mechanisms enable adjusting the magnitude of a force imposed on the axle of the respective cylinder (i.e., the anilox roller 175 or the impression cylinder 174) to push it toward the printing cylinder 171. In some embodiments, the pressure adjustments are made using a screw mechanism.

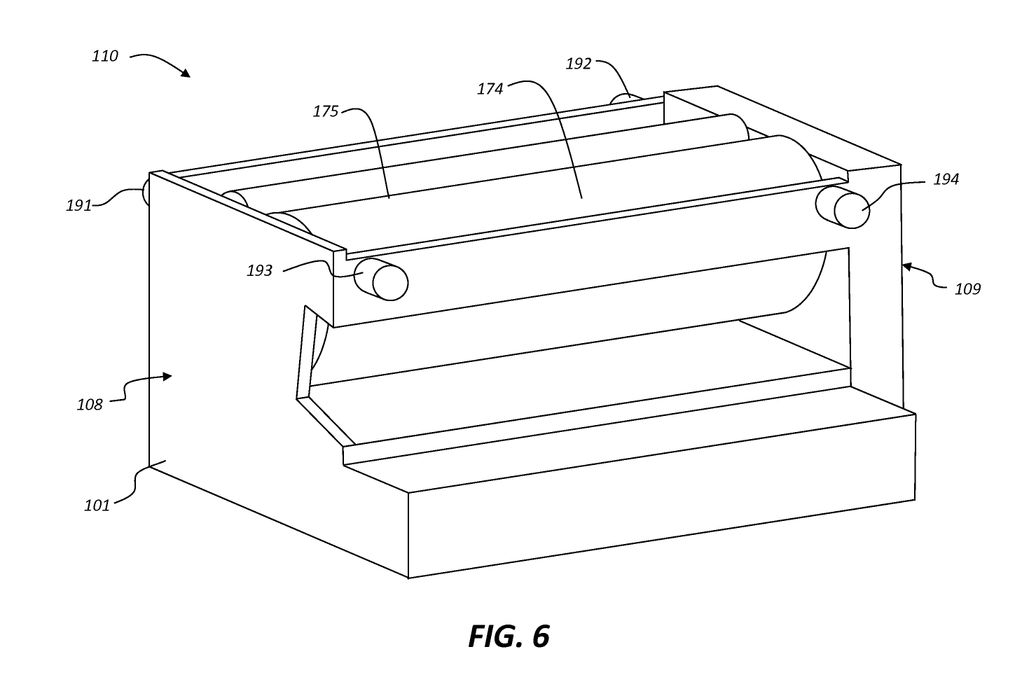

FIG. 6 shows a perspective of a portion of print module 110 from FIG. 5. (For clarity, the printing cylinder 171 is hidden in FIG. 6.) Anilox roller 175, impression cylinder 174 and printing cylinder 171 (FIG. 5) extend from a first side 108 to a second side 109 of frame 101. In addition to anilox cylinder pressure adjustment 191 positioned near the first side 108, there is also an anilox cylinder pressure adjustment 192 positioned near the second side 109 so that pressure can be adjusted as needed across the length of anilox roller 175. Similarly, in addition to impression cylinder pressure adjustment 193 positioned near the first side 108, there is also an impression cylinder pressure adjustment 194 positioned near the second side 109 so that pressure can be adjusted as needed across the length of impression cylinder 174.

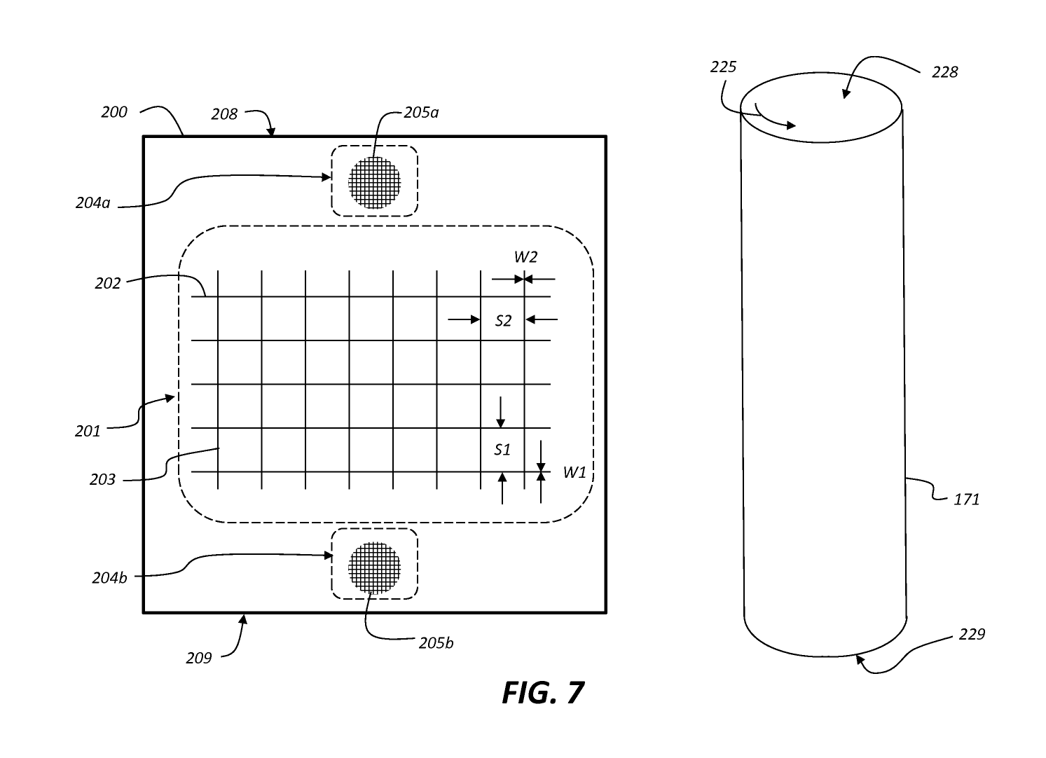

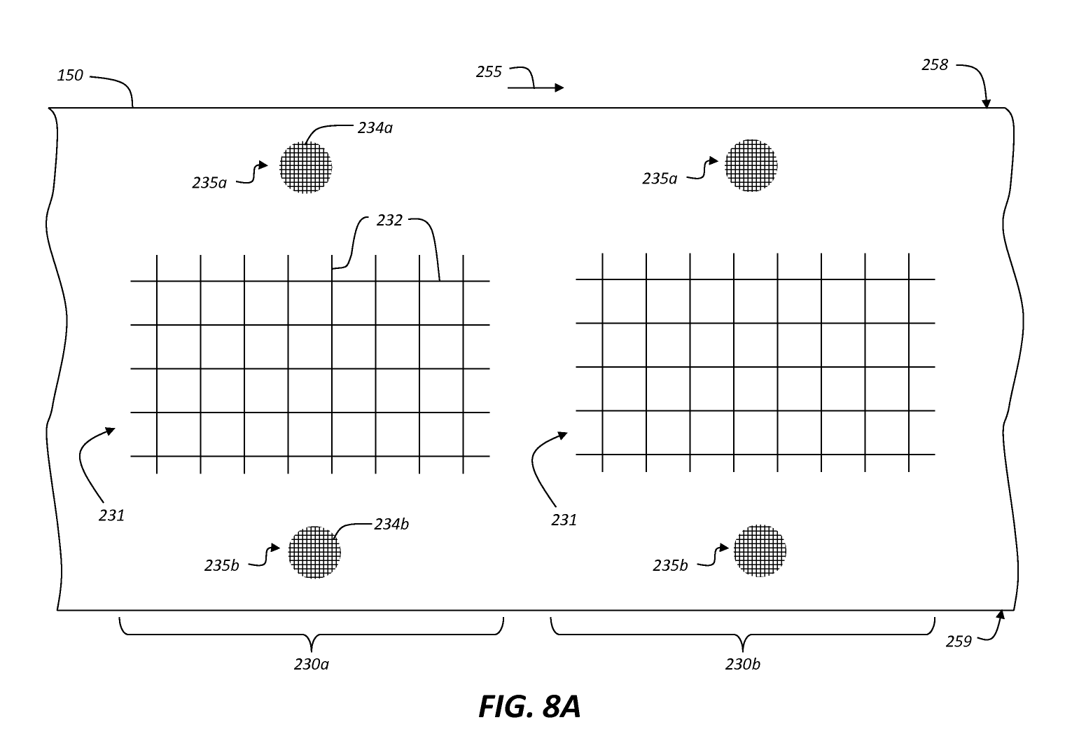

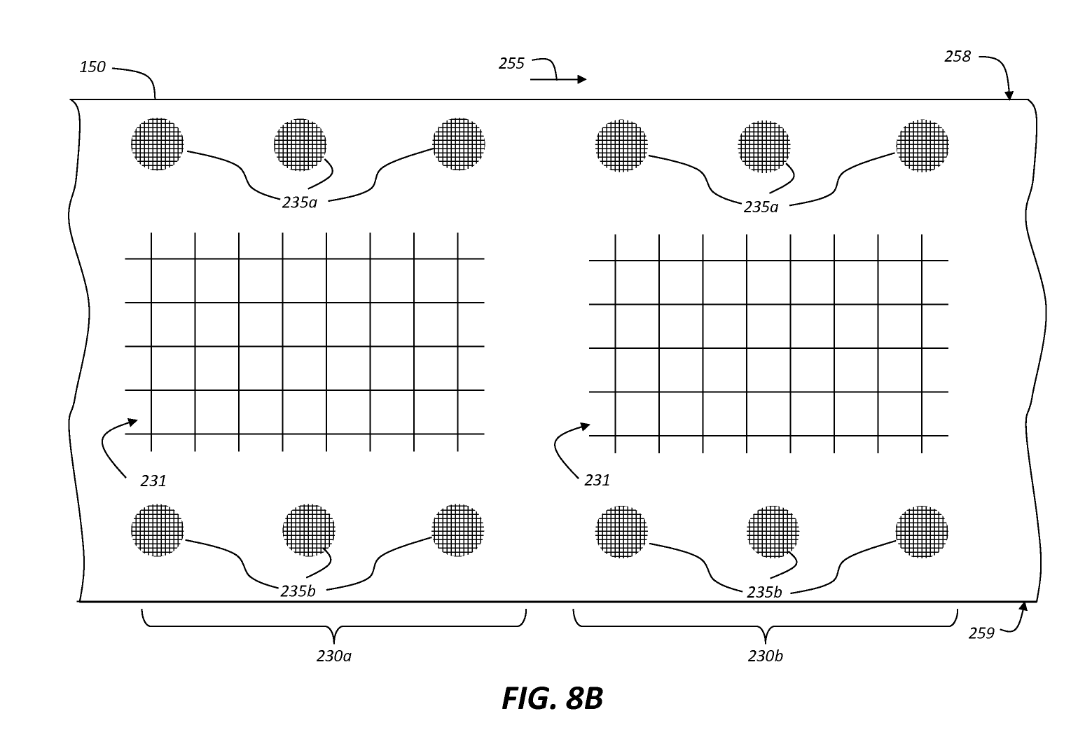

FIG. 7 shows a top view of a flexographic printing plate 200 according to an exemplary embodiment of the invention, together with a printing cylinder 171 around which the flexographic printing plate 200 is to be wrapped. FIG. 8A shows corresponding patterns printed on substrate 150 using the flexographic printing plate 200.

The flexographic printing plate 200 includes a first edge 208, which will be near first end 228 of printing cylinder 171, and a second edge 209 which will be near second end 229 of printing cylinder 171 when flexographic printing plate 200 is mounted on printing cylinder 171.

The flexographic printing plate 200 includes an image region 201 having a plurality of raised printing elements 202, 203 for printing an image pattern 231 on a surface of substrate 150. The image region 201 in the illustrated example includes an array of horizontal raised printing elements 202 and an array of vertical raised printing elements 203 for printing a grid pattern on the surface of the substrate 150.

In other embodiments, the horizontal raised printing elements 202 and the vertical raised printing elements 203 are provided on two separate printing plates, such as the flexographic printing plates 112 and 132 shown in FIG. 1. Motivation for providing the horizontal raised printing elements 202 and the vertical raised printing elements 203 of a grid on two separate flexographic printing plates is that intersecting raised printing features can result in undesirable line broadening at the intersections.

The flexographic printing plate 200 also includes two pressure characterization regions 204a, 204b outside the image region 201. Each pressure characterization region 204a, 204b includes a respective plurality of raised printing elements 205a, 205b arranged to print respective pressure characterization patterns 235a, 235b on substrate 150 (FIG. 8A).

With continued reference to FIGS. 7 and 8A, as the printing cylinder 220 rotates in rotation direction 225 in the flexographic printing system 100 (FIG. 1), the web of substrate 150 is advanced along web advance direction 255 and ink is transferred from the raised printing elements 202, 203, 205a, 205b on the flexographic printing plate 200 to the substrate 150 to print a series of successive printed images 230a, 230b. The printed images 230a, 230b each include printed image patterns 231 having printed image features 232 corresponding to the raised printing elements 202, 203 in the image region 201. Similarly, the printed images 230a, 230b also include printed pressure characterization patterns 235a, 235b having printed characterization features 234a, 234b corresponding to the raised printing elements 205a, 205b in the pressure characterization regions 204a, 204b.

The use of pressure characterization patterns 235a, 235b has been found to be particularly advantageous when the raised printing elements 202, 203 have a smallest lateral dimension (e.g., line widths W1 and W2, respectively) that is less than 25 microns, and even more so when the smallest lateral dimension is less than 10 microns. This is because it is difficult to determine precisely on a sparse array of narrow features how much the ink transfer pressure needs to be increased or decreased in order to provide the desired feature width.

In a preferred embodiment, the raised printing elements 205a, 205b in the pressure characterization regions 204a, 204b, that are used for printing the pressure characterization patterns 235a, 235b have a smallest lateral dimension which is substantially equal to the smallest lateral dimension (i.e., W1 and W2) of the raised printing elements 202, 203 that are used for printing the image pattern 231. “Substantially equal” in this context means within ±20% or ±1 micron, whichever is larger. However, the characteristic spacings (unlabelled) between raised printing elements 205a, 205b in the pressure characterization regions 204a, 204b are typically significantly smaller than characteristic spacings (i.e., line spacings S1 and S2) between the raised printing elements 202, 203 that are used for printing the image pattern 231. For example, the line spacings S1 and S2 between the raised printing elements in the plurality of raised printing elements 202, 203 can be about 200 microns to about 500 microns and the characteristic spacing between raised printing elements 205a, 205b can be less than 100 microns. The line widths W1 and W2 can be about 5 microns. As a result of the higher density, measurements of optical properties of printed pressure characterization patterns 235a, 235b can be performed with a better signal-to-noise ratio than similar optical properties of printed image pattern 231.

In the exemplary embodiment illustrated in FIG. 8A, the pressure characterization patterns 235a, 235b are grid patterns including two sets of parallel lines at different orientations. In alternate embodiments, the pressure characterization patterns 235a, 235b can use other types of patterns. For example, in some embodiments the pressure characterization patterns 235a, 235b can include only a single grouping of parallel lines (e.g., horizontal lines, vertical lines, or lines of some intermediate orientation.) In various embodiments, the pressure characterization patterns 235a, 235b used in different print modules (e.g., print modules 110, 120, 130 and 140 in the flexographic printing system 100 of FIG. 1) can be different from each other.

FIG. 8A shows one pressure characterization pattern 235a proximate to edge 258 and one pressure characterization pattern 235b proximate to edge 259 for each printed image 230a, 230b. In other embodiments, there can be a plurality of pressure characterization patterns 235a, 235b near the respective edges 258, 259 of the substrate 150 for each printed image 230a, 230b, separated from each other along web advance direction 255 as illustrated in FIG. 8B. Since the anilox roller 175 (FIG. 4) typically has a smaller diameter than the printing cylinder 171, the anilox roller 175 rotates more than once during the printing of an image pattern 231. Periodic variations in the measured optical properties of the pressure characterization patterns 235a, 235b can be used in some embodiments to identify variations in anilox roller pressure due, for example, to eccentricity.

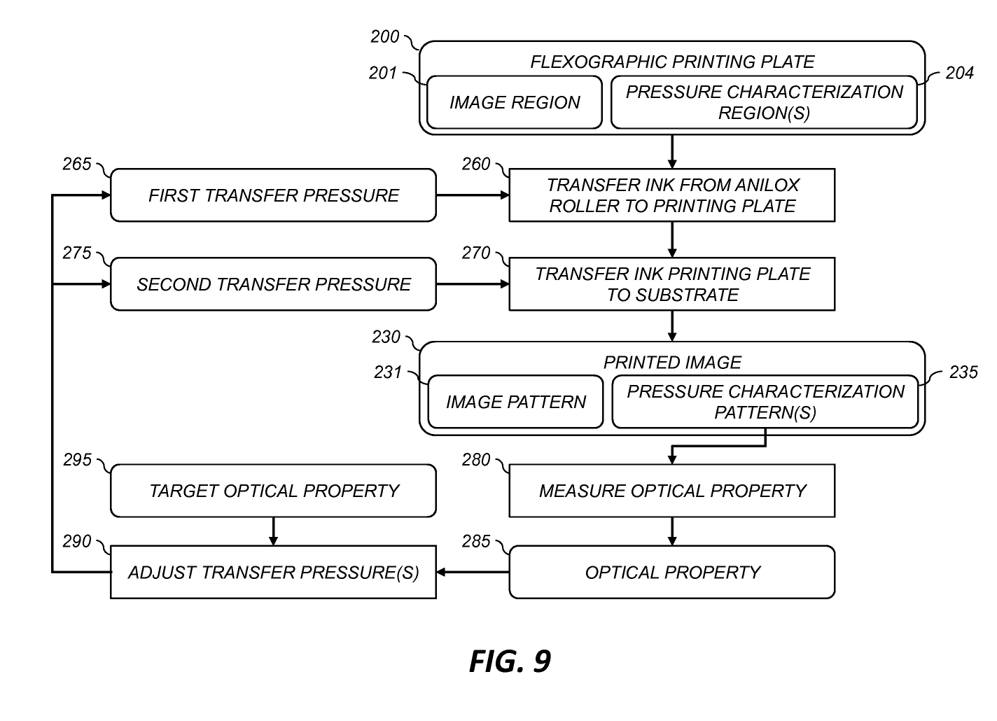

FIG. 9 shows a flowchart of a method for adjusting the transfer pressures in a flexographic printing system 100 (FIG. 1) in accordance with the present invention. As discussed earlier with reference to FIG. 7, a flexographic printing plate 200 is provided which includes an image region 201 and one or more pressure characterization region(s) 204. The image region 201 includes a plurality of raised printing elements 202, 203 (FIG. 7) arranged to print an image pattern 231. Similarly, the pressure characterization region(s) 204 include a plurality of raised printing elements 205a, 205b (FIG. 7) arranged to print corresponding pressure characterization pattern(s) 235.

A transfer ink from anilox roller to printing plate step 260 is used to transfer ink to the flexographic printing plate 200. The ink is transferred at a nip formed between the anilox roller 175 (FIG. 4) and the printing cylinder 171 (FIG. 4), onto which the flexographic printing plate 200 has been mounted. An adjustable first transfer pressure 265 (P1) between the anilox roller 175 and the printing cylinder 171 controls the transfer of the ink to the flexographic printing plate 200.

A transfer ink from printing plate to substrate step 270 is used to transfer ink from the flexographic printing plate 200 to the substrate 150 (FIG. 8A), thereby forming a printed image 230. The ink is transferred as the substrate is advanced through a nip formed between the printing cylinder 171 (FIG. 4) and the impression cylinder 174. An adjustable second transfer pressure 275 (P2) between the printing cylinder 171 and the impression cylinder 174 controls the transfer of the ink to the substrate 150. The printed image 230 includes an image pattern 231 formed by the raised printing elements 202, 203 (FIG. 7) in the image region 201, as well as pressure characterization pattern(s) 235 formed by the raised printing elements 205a, 205b (FIG. 7) in the pressure characterization region(s) 204.

A measure optical property step 280 is used to measure an optical property 285 of at least one of the printed pressure characterization pattern(s) 235. The measure optical property step 280 can use a variety of types of optical measurement to measure a variety of different types of optical properties 285 in various embodiments of the invention. Within the context of the present invention, an “optical property” is one that can be measured with an optical device (e.g., a densitometer or a digital camera).

In an exemplary embodiment, the optical property 285 is an integrated optical density. In this case, an optical densitometer can be used to measure an integrated optical reflection density or an integrated optical transmission density. Alternately, the optical densitometer can be used to measure an integrated optical reflectance or an integrated optical transmittance. Note that there is a simple mathematical relationship between reflection density (D_{R}) and reflectance (R) given by D_{R}=−log(R), so these quantities can be viewed as representations of the same quantity. Likewise, there is a simple mathematical relationship between transmission density (D_{T}) and transmittance (T) given by D_{T}=−log(T). Optical densitometers are well known in the art, and generally include a light source which illuminates the substrate 150 with a uniform region of light and measures the light that is either reflected from or transmitted through the substrate to determine the corresponding optical density value.

In some embodiments, the integrated optical density properties (e.g., the integrated optical reflection density, the integrated optical transmission density, the integrated optical reflectance or the integrated optical transmittance) can be measured within a single field-of-view within the pressure characterization pattern(s) 235. In other embodiments, a plurality of integrated optical density measurements can be made using different fields-of-view within the pressure characterization pattern(s) 235. The resulting optical density values can then be averaged to reduce measurement noise and the resulting average optical density can be used as the optical property 285.

In other embodiments, rather than measuring an integrated optical density, the local optical density properties (e.g., the local optical reflection density, the local optical transmission density, the local optical reflectance or the local optical transmittance) of the printed characterization features 234a, 234b (FIG. 8A) can be measured and used for the optical property 285. The local optical density properties can be measured using an optical densitometer having a small illumination area. Alternatively, it can be measured by using an image capture device such as a digital camera to capture an image of the pressure characterization pattern(s) 235, and the resulting image can be analyzed (with appropriate calibration) to estimate the local optical density properties. In this case, it can be desirable to measure the local optical density properties for a plurality of the printed characterization features 234a, 234b (e.g., for a plurality of lines), and then determine an average value which is used as the optical property 285.

In other embodiments, the measured optical property 285 can be a geometric characteristic of the printed pressure characterization pattern(s) 235 that is determined by analyzing a digital image of the pressure characterization pattern(s) 235 captured using an appropriate image capture device such as a digital camera. For example, the geometric characteristic can be a lateral dimension of the printed characterization features 234a, 234b (FIG. 8A) in the printed pressure characterization pattern(s) 235. In an exemplary embodiment, the line widths (e.g., the full-width half-maximum line width) for a plurality of the printed characterization features 234a, 234b are determined by analyzing a captured digital image, and the average line width can be determined and used as the optical property 285.

In a preferred embodiment, the measure optical property step 280 is performed using an optical measurement device which is integrated into the flexographic printing system (FIG. 1). For example, the optical measurement device can be an in-line densitometer, or an in-line digital image capture system such as the imaging system 177 shown in FIG. 4. In such embodiments, measuring the measure optical property step 280 includes advancing the substrate 150 such that the at least one pressure characterization pattern 235 is located within a field of view of the optical measurement device (e.g., the imaging system 177), which is then controlled by controller 103 to measure the appropriate optical property 285. For cases where pressure characterization patterns 235a, 235b (FIG. 8A) are printed near opposite edges 258 and 259 of substrate 150, it is useful to provide two imaging systems 177 proximate to the edges 258 and 259 of the substrate 150.

In an alternate embodiment, the measure optical property step 280 can be performed offline by removing a piece of substrate 250 from the web and bringing it to a separate optical measurement device (not shown). An operator can then perform a manual measurement to determine the optical property 285.

An adjust transfer pressure(s) step 290 is used to adjust one or both of the first transfer pressure 265 and the second transfer pressure 275 responsive to the measured optical property 285 determined for at least one of the pressure characterization pattern(s) 235. Any appropriate process control process known in the art can be used to adjust the transfer pressures. In an exemplary embodiment, the measured optical property is compared to a predefined target optical property 295 and the difference can be used to determine a transfer pressure adjustment. The transfer pressure adjustments can be made using, for example, the anilox cylinder pressure adjustments 191, 192 or the impression cylinder pressure adjustments 193, 194 described above with reference to FIGS. 5 and 6. For example, if it determined that the measured optical density for the pressure characterization pattern 235 is too low relative to the target optical property 295, then the second transfer pressure 275 can be increased accordingly. Likewise, if it determined that the measured optical density for the pressure characterization pattern 235 is too high relative to the target optical property 295, then the second transfer pressure 275 can be decreased accordingly.

For cases where pressure characterization patterns 235a, 235b (FIG. 8A) are printed along opposing edges 258, 259 of the substrate 150, optical properties 285 determined from both of the pressure characterization patterns 235a, 235b can be used to determine the transfer pressure adjustments. For example, if it determined that the measured optical density for the pressure characterization pattern 235a along the left edge of the substrate 150 (FIG. 8A) is too low relative to the target optical property 295, then the second transfer pressure 275 along that edge can be increased accordingly using the impression cylinder pressure adjustments 194. Similarly, if it determined that the measured optical density for the pressure characterization pattern 235b along the right edge of the substrate 150 (FIG. 8A) is too high relative to the target optical property 295, then the second transfer pressure 275 along that edge can be decreased accordingly using the corresponding impression cylinder pressure adjustments 193.

In some embodiments, the transfer pressure adjustments can be performed automatically using automated adjustment mechanisms (e.g., motors or hydraulic systems) that are controlled by the controller 103. In other embodiments, the transfer pressure adjustments can be performed manually by an operator. In some embodiments, adjust transfer pressure(s) step 290 can include an automatic analysis step which compares the measured optical property 285 to the target optical property 295 and determines an appropriate transfer pressure adjustment. A user interface can then be used to communicate the recommended transfer pressure adjustment to the operator, who can then manually adjust the transfer pressure controls to apply the transfer pressure adjustment.

In some embodiments, a plurality of different optical properties 285 can be determined and used in the process of adjusting the transfer pressures. For example, both the line width and the local optical density of the printed characterization features 234a, 234b (FIG. 8A) can be determined. The adjust transfer pressure(s) step can then adjust one or both of the first transfer pressure 265 and the second transfer pressure 275 responsive to both of the measured optical properties. In this case, experiments can be performed to determine a model of how the line width and the local optical density vary as a function of the transfer pressures. The model can then be used to determine appropriate transfer pressure adjustments given differences between the measured optical properties 285 and corresponding target optical properties 295.

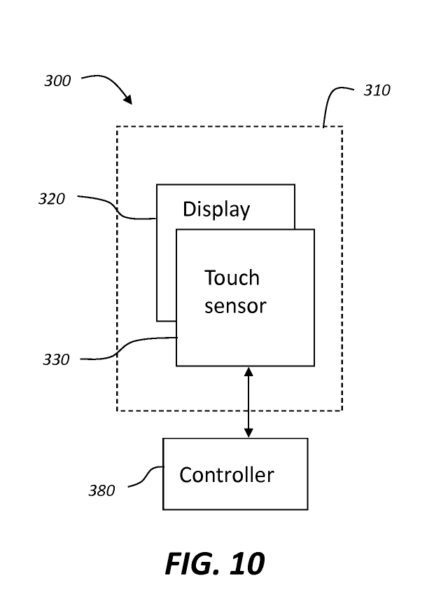

FIG. 10 shows a high-level system diagram for an apparatus 300 having a touch screen 310 including a display device 320 and a touch sensor 330 that overlays at least a portion of a viewable area of display device 320. Touch sensor 330 senses touch and conveys electrical signals (related to capacitance values for example) corresponding to the sensed touch to a controller 380. Touch sensor 330 is an example of an article that can be printed on one or both sides by the flexographic printing system 100 including print modules that incorporate embodiments of the method of setting the ink transfer pressures described above.

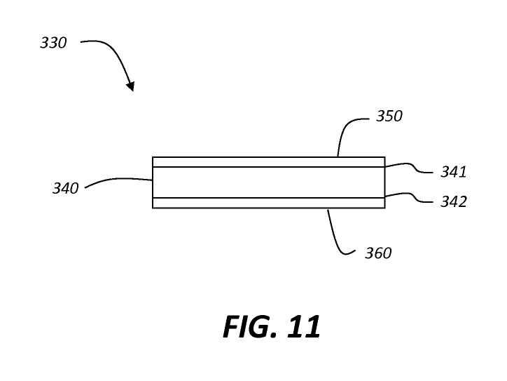

FIG. 11 shows a schematic side view of a touch sensor 330. Transparent substrate 340, for example polyethylene terephthalate, has a first conductive pattern 350 printed on a first side 341, and a second conductive pattern 360 printed on a second side 342. The length and width of the transparent substrate 340, which is cut from the take-up roll 104 (FIG. 1), is not larger than the flexographic printing plates 112, 122, 132, 142 of flexographic printing system 100 (FIG. 1), but it could be smaller than the flexographic printing plates 112, 122, 132, 142. Optionally, the first conductive pattern 350 and the second conductive pattern 360 can be plated using a plating process for improved electrical conductivity after flexographic printing and curing of the patterns. In such cases it is understood that the printed pattern itself may not be conductive, but the printed pattern after plating is electrically conductive.

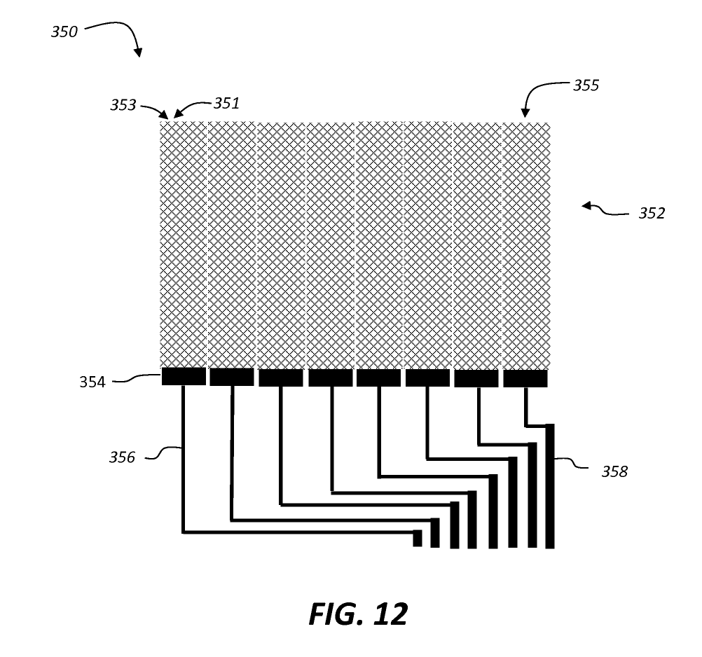

FIG. 12 shows an example of a conductive pattern 350 that can be printed on first side 341 (FIG. 11) of transparent substrate 340 (FIG. 11) using one or more print modules such as print modules 120 and 140 of flexographic printing system (FIG. 1). Conductive pattern 350 includes a grid 352 including grid columns 355 of intersecting fine lines 351 and 353 that are connected to an array of channel pads 354. Interconnect lines 356 connect the channel pads 354 to the connector pads 358 that are connected to controller 380 (FIG. 10). Conductive pattern 350 can be printed by a single print module 120 in some embodiments. However, because the optimal print conditions for fine lines 351 and 353 (e.g., having line widths on the order of 4 to 8 microns) are typically different than for printing the wider channel pads 354, connector pads 358 and interconnect lines 356, it can be advantageous to use one print module 120 for printing the fine lines 351 and 353 and a second print module 140 for printing the wider features. Furthermore, for clean intersections of fine lines 351 and 353 it can be further advantageous to print and cure one set of fine lines 351 using one print module 120, and to print and cure the second set of fine lines 353 using a second print module 140, and to print the wider features using a third print module (not shown in FIG. 1) configured similarly to print modules 120 and 140.

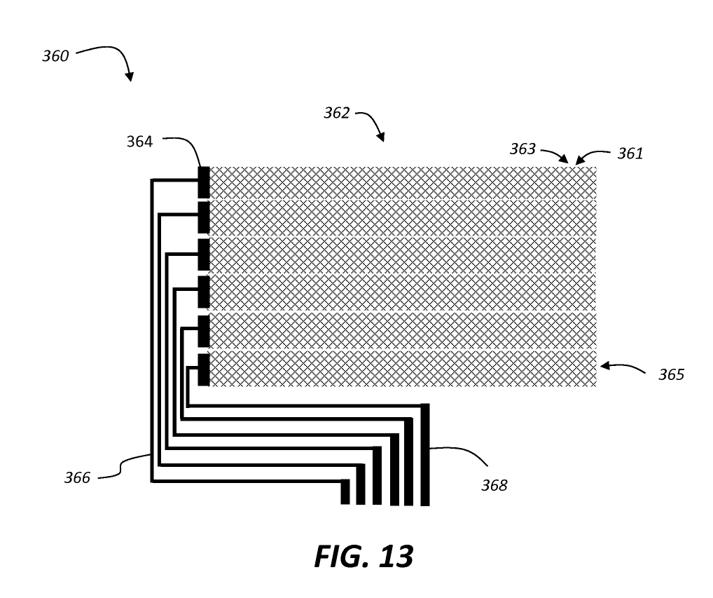

FIG. 13 shows an example of a conductive pattern 360 that can be printed on second side 342 (FIG. 11) of substrate 340 (FIG. 11) using one or more print modules such as print modules 110 and 130 of flexographic printing system (FIG. 1). Conductive pattern 360 includes a grid 362 including grid rows 365 of intersecting fine lines 361 and 363 that are connected to an array of channel pads 364. Interconnect lines 366 connect the channel pads 364 to the connector pads 368 that are connected to controller 380 (FIG. 10). In some embodiments, conductive pattern 360 can be printed by a single print module 110. However, because the optimal print conditions for fine lines 361 and 363 (e.g., having line widths on the order of 4 to 8 microns) are typically different than for the wider channel pads 364, connector pads 368 and interconnect lines 366, it can be advantageous to use one print module 110 for printing the fine lines 361 and 363 and a second print module 130 for printing the wider features. Furthermore, for clean intersections of fine lines 361 and 363 it can be further advantageous to print and cure one set of fine lines 361 using one print module 110, and to print and cure the second set of fine lines 363 using a second print module 130, and to print the wider features using a third print module (not shown in FIG. 1) configured similarly to print modules 110 and 130.

Alternatively in some embodiments conductive pattern 350 can be printed using one or more print modules configured like print modules 110 and 130, and conductive pattern 360 can be printed using one or more print modules configured like print modules 120 and 140 of FIG. 1.

With reference to FIGS. 10-13, in operation of touch screen 310, controller 380 can sequentially electrically drive grid columns 355 via connector pads 358 and can sequentially sense electrical signals on grid rows 365 via connector pads 368. In other embodiments, the driving and sensing roles of the grid columns 355 and the grid rows 365 can be reversed.

The invention has been described in detail with particular reference to certain preferred embodiments thereof, but it will be understood that variations and modifications can be effected within the spirit and scope of the invention.

### PARTS LIST

10 impression cylinder
12 substrate
14 printing cylinder
16 printing plate
18 anilox roller
20 fountain roller device
22 fountain roller
24 pan
26 doctor blade
30 reservoir chamber system
32 reservoir chamber
34 blade
38 ink exit
39 ink entry
39 blade
100 flexographic printing system
101 frame
102 supply roll
103 controller
104 take-up roll
105 roll-to-roll direction
106 roller
107 roller
108 first side
109 second side
110 print module
111 printing cylinder
112 flexographic printing plate
113 raised features
114 impression cylinder
115 anilox roller
116 UV curing station
120 print module
121 printing cylinder
122 flexographic printing plate
124 impression cylinder
125 anilox roller
126 UV curing station
130 print module
131 printing cylinder
132 flexographic printing plate
134 impression cylinder
135 anilox roller
136 UV curing station
140 print module
141 printing cylinder
142 flexographic printing plate
144 impression cylinder
145 anilox roller
146 UV curing station
150 substrate
151 first side
152 second side
160 ink pan
161 fountain roller
162 front wall
163 rear wall
164 floor
165 ink
166 pivot axis
167 lip
168 lowest portion
171 printing cylinder
172 flexographic printing plate
173 raised features
174 impression cylinder
175 anilox roller
176 UV curing station
177 imaging system
180 doctor blade
181 contact point
182 contact point
183 contact point
184 contact point
191 anilox cylinder pressure adjustment
192 anilox cylinder pressure adjustment
193 impression cylinder pressure adjustment
194 impression cylinder pressure adjustment
200 flexographic printing plate
201 image region
202 raised printing elements
203 raised printing elements
204 pressure characterization region(s)
204a pressure characterization region
204b pressure characterization region
205a raised printing elements
205b raised printing elements
208 first edge
209 second edge
225 rotation direction
228 first end
229 second end
230 printed image
230a printed image
230b printed image
231 image pattern
232 printed image features
234a printed characterization features
234b printed characterization features
235 pressure characterization pattern(s)
235a pressure characterization pattern
235b pressure characterization pattern
255 web advance direction
258 first edge
259 second edge
260 transfer ink from anilox roller to printing plate step
265 first transfer pressure
270 transfer ink printing plate to substrate step
275 second transfer pressure
280 measure optical property step
285 optical property
290 adjust transfer pressure(s) step
295 target optical property
300 apparatus
310 touch screen
320 display device
330 touch sensor
340 transparent substrate
341 first side
342 second side
350 conductive pattern
351 fine lines
352 grid
353 fine lines
354 channel pads
355 grid column
356 interconnect lines
358 connector pads
360 conductive pattern
361 fine lines
362 grid
363 fine lines
364 channel pads
365 grid row
366 interconnect lines
368 connector pads
380 controller
F force
P1 transfer pressure
P2 transfer pressure
S1 line spacing
S2 line spacing
W1 line width
W2 line width

1. A method of controlling an ink transfer pressure between cylinders in a flexographic printing system, the method comprising:
providing a flexographic printing plate on a printing cylinder, the flexographic printing plate including:
an image region including a plurality of raised printing elements arranged to print an image pattern having printed image features corresponding to the raised printing elements, wherein the printed image features have a smallest lateral dimension that is less than 25 microns; and
one or more pressure characterization regions outside the image region, each pressure characterization region including a plurality of raised printing elements arranged to print a pressure characterization pattern having printed characterization features corresponding to the raised printing elements;
transferring ink from an anilox cylinder to the flexographic printing plate on the printing cylinder, wherein the anilox cylinder and the printing cylinder contact each other with a first transfer pressure;
advancing a recording medium through a nip between the printing cylinder and an impression cylinder such that ink is transferred from the flexographic printing plate to the recording medium to print the image pattern and the pressure characterization patterns, wherein the printing cylinder and the impression cylinder contact each other with a second transfer pressure;
measuring an optical property of at least one printed pressure characterization pattern; and
adjusting one or both of the first and second transfer pressures responsive to the measured optical property of the at least one printed pressure characterization pattern.

2. The method according to claim 1, wherein a first pressure characterization region including a first pressure characterization pattern is displaced from the image region in a first direction, and a second pressure characterization region including a second pressure characterization pattern is displaced from the image region in a second direction.

3. The method according to claim 2, wherein the first pressure characterization pattern is printed proximate to a first edge of the recording medium and the second pressure characterization pattern is printed proximate to a second edge of the recording medium opposite the first edge.

4. The method according to claim 2, wherein the adjustment of at least one of the transfer pressures is responsive to the measured optical property of both the first pressure characterization pattern and the second pressure characterization pattern.

5. The method according to claim 4, wherein the adjustment of at least one of the transfer pressures is adjustable at first and second positions along the length of the corresponding nip, and wherein the transfer pressure at the first position is adjusted responsive to the measured optical property of the first pressure characterization pattern and the transfer pressure at the second position is adjusted responsive to the measured optical property of the second pressure characterization pattern.

6. The method according to claim 1, wherein the one or more pressure characterization regions includes a first pressure characterization region including a plurality of raised printing elements arranged to print a first pressure characterization pattern, and a second pressure characterization region including a plurality of raised printing elements arranged to print a second pressure characterization pattern, the second pressure characterization pattern being displaced from the first pressure characterization pattern along a web advance direction.

7. The method according to claim 1, wherein measuring the optical property includes measuring an integrated optical reflection density or an integrated optical transmission density or an integrated optical reflectance or an integrated optical transmittance.

8. The method according to claim 1, wherein measuring the optical property includes measuring an optical reflection density, an optical transmission density, an optical reflectance, or an optical transmittance of the printed characterization features.

9. The method according to claim 1, wherein measuring the optical property includes measuring a lateral dimension of the printed pressure characterization features.

10. The method according to claim 1, wherein the raised printing elements in the pressure characterization regions have a smallest lateral dimension that is substantially equal to a smallest lateral dimension of the raised printing elements in the image region.

11. The method according to claim 10, wherein at least some of the raised printing elements in the image region are configured to print an array of lines, and wherein the smallest lateral dimension corresponds to a width of the lines.

12. The method according to claim 10, wherein a first characteristic spacing between the raised printing elements in the image region is greater than a second characteristic spacing between the raised printing elements in the pressure characterization regions.

13. The method of claim 1, wherein the recording medium is a web of transparent film.

14. The method of claim 1, wherein the flexographic printing system further includes a controller.

15. The method of claim 14, wherein measuring the optical property includes advancing the recording medium such that the at least one pressure characterization pattern is located within a field of view of an optical measurement device controlled by the controller.

16. The method of claim 14, wherein at least one of the transfer pressures is adjusted automatically using an automated adjustment mechanism that is controlled by the controller.

17. The method of claim 1, wherein at least one of the transfer pressures is adjusted responsive to a difference between the measured optical property and a predefined target optical property.

18. The method of claim 1, wherein at least one of the pressure characterization patterns includes at least one array of parallel lines.

19. The method of claim 18, wherein at least one of the pressure characterization patterns includes at least a first array of parallel lines in a first orientation and a second array of parallel lines in an orientation which is substantially orthogonal to the first orientation.

20. The method of claim 1, wherein the flexographic printing system includes a plurality of print modules, and wherein the pressure characterization patterns for a first print module are different from the pressure characterization patterns for a second print module.

21. The method of claim 1, further including measuring a second optical property of the at least one printed pressure characterization pattern, and wherein the adjustment of one or both of the first and second transfer pressures is responsive to the second optical property.

22. An article including a substrate that has been printed after setting at least one ink transfer pressure between cylinders according to the method of claim 1.

23. The article of claim 22, wherein the article is a touch screen display.
